(19) United States
(12) Patent Application Publication
(10) Pub. No.: US 2010/0032038 A1
(43) Pub. Date: Feb. 11, 2010

(54) SHARED GAS VALVE

(76) Inventors: Qibiao XIE, Guangdong (CN); Rui-Yan Hsiao, Guangdong (CN)

Correspondence Address: BLANK ROME LLP, WATERGATE, 600 NEW HAMPSHIRE AVENUE, N.W., WASHINGTON, DC, 20037, US

(21) Appl. No.: 12/534,200

(22) Filed: Aug. 3, 2009

(30) Foreign Application Priority Data
Aug. 5, 2008 (CN) 200810030042.4

(51) Int. Cl. F16K 11/00

(52) U.S. Cl. 137/625.46

(57) ABSTRACT

The invention is a shared gas valve which has a valve body with a valve core therein. The valve body has inlet for gas a, the valve core has a gas passage therein with an inlet for gas a and an inlet for gas b on each side. The inlet for gas a and inlet for gas b can connect with said gas passage separately. The valve core has another opening of supplementary inlet for gas a. The valve body has a primary gasway and a supplementary gasway therein and each gasway has a outlet nozzle. The primary gasway is connected with gas passage directly and the supplementary gasway can connect with the a supplementary gas inlet. This invention overcomes the shortages of traditional valve in structure for that there is no need to replace any component or part when changing the gas. It is safe and convenient for use. At the same time, waste could be reduced and the risk of incurring disastrous accident is lessened and thus benefit mankind.

### TECHNICAL FIELD

This invention relates to a gas valve and, more particularly to a shared gas valve which is available for two kinds of gases.

### BACKGROUND OF THE INVENTION

As different gas has different characteristics, such as heat load, combustion potential and wobbe index, different gas valve should be provided for different gas so that the gas can be burned completely to get its maximum heat energy. Traditional gas valve can be used for only one gas, in the event of changing gas, the gas valve or internal parts of the gas valve must be replaced so that the other gas can be used in the same burner. However, this may bring troubles to the manufactures and users, and cause waste of resources. Moreover, there will be risk and even disastrous accident may happen if users replace the gas valves themselves.

### SUMMARY OF THE INVENTION

The purpose of this invention is to provide a gas valve which is available for two kinds of gases.

For this purpose, a shared gas valve is disclosed comprising a valve body with a valve core therein, which connects to a rotary shaft; the said valve body has a gas inlet, the said valve core has a gas passage therein with an inlet for gas a and an inlet for gas b on each side, the inlet for gas a and the inlet for gas b connect with gas inlet; the valve core has another supplementary gas inlet for gas a; the said valve body has a primary gasway and a supplementary gasway therein and a nozzle is set at the opening of each gasway; the primary gasway is connected with gas passage directly and the supplementary gasway can connect with the a supplementary gas inlet; when using gas a, the inlet for gas a can connect with the primary gasway via gas passage, the supplementary gasway can connect with gas passage via supplementary inlet for gas a while the inlet for gas b is blocked by the inside wall of valve body; when using gas b, inlet for gas b can connect with the primary gasway via gas passage and the inlet for gas a and the a supplementary gas inlet are blocked by the inside wall of the valve body.

As an improvement of the said invention, the said valve core has an opening of a small igniter inlet located beside the inlet for gas a, the a small igniter inlet connects with the gas passage and has its axis in the same cross-section of the valve core with the inlet for gas a; the said valve core has an opening of a small igniter inlet for gas b located beside the gas inlet for gas b, the small igniter inlet for gas b connects with the gas passage and has its axis in the same cross-section of the valve core with the gas inlet for gas b.

As a further improvement of the said invention, the said valve core has an opening of a supplementary small igniter inlet located beside the a supplementary gas inlet, the a supplementary small igniter inlet connects with the gas passage and has its axis in the same cross-section of the valve core with the a supplementary gas inlet.

The said inlet for gas a and inlet for gas b have their axis on the same cross-section of the said valve core, and the supplementary gas inlet for gas a and the inlet for gas a are located along the axis of the core.

The benefits of this invention are: the said valve core has two gas inlets and one supplementary inlet corresponding to either gas inlet. The valve body comprises the primary gasway corresponding to two gas inlets, and the supplementary gasway corresponding to supplementary gas inlet. Thus it overcomes the shortages of traditional valve in structure for that there is no need to replace any component or part when changing the gas. At the same time, waste could be reduced and the risk of incurring disastrous accident is lessened and thus benefit the mankind.

### BRIEF DESCRIPTION OF DRAWINGS

The invention may be more completely understood in consideration of the following detailed description of various embodiments of the invention in connection with the accompanying drawings, in which:

FIG. 1 is the perspective view of the valve;

FIG. 2 is the sectional cutaway view of the valve;

FIG. 3 is the exploded view of the valve in one direction;

FIG. 4 is the exploded view of the valve in another direction;

FIG. 5 is the cutaway view of valve body;

FIG. 6 is the structural view of the valve core.

### DETAILED DESCRIPTION OF THE INVENTION

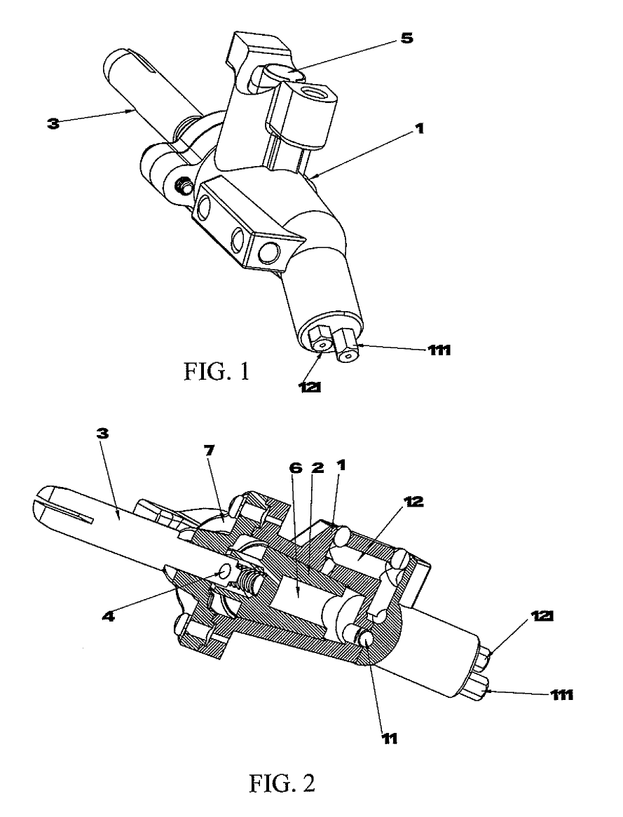

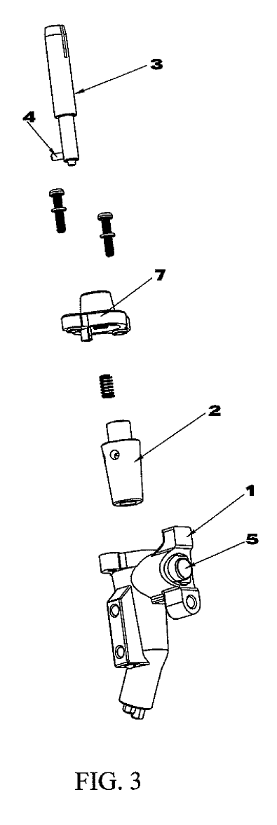

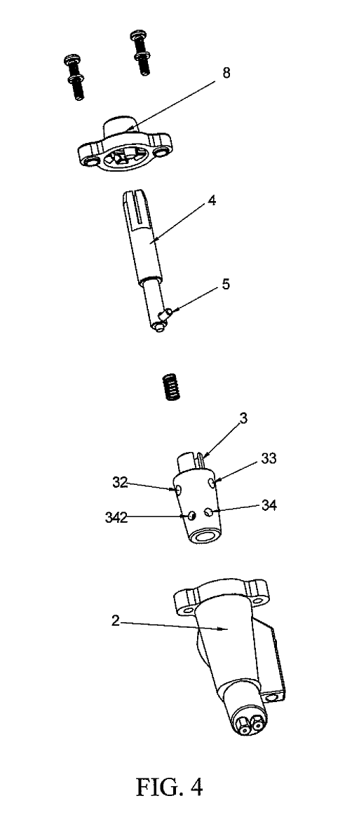

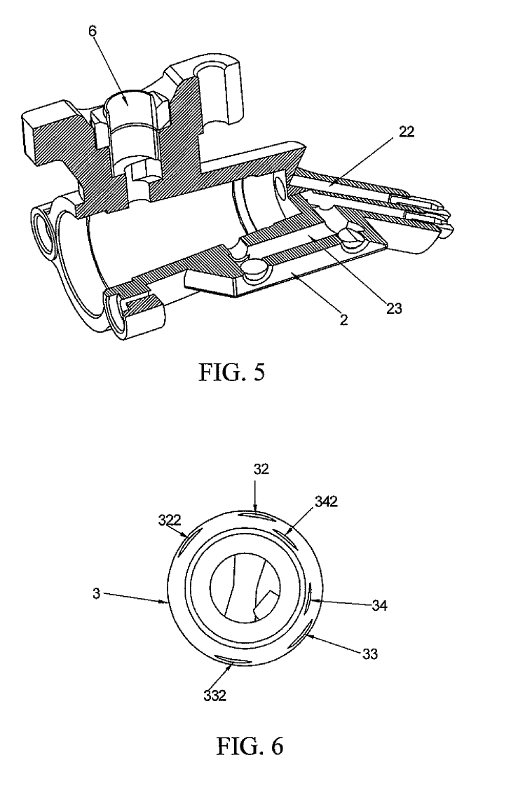

With reference to FIG. 1-5, a shared gas valve comprises a valve body with a valve cover 7 thereon and a valve core 2 therein. The valve core 2 is connected to a rotary shaft 3 by a adjusting pin 4, the valve body has gas inlet 5 and the valve core s has a gas passage 6 therein.

As the figures show, the valve core has a inlet for gas a 21 and a inlet for gas b 22 on each side. The inlet for gas a 21 and the inlet for gas b 22 have their axis on the same cross-section of the valve core 2, the inlet for gas a 21 and the inlet for gas b 22 can connect with the gas inlet 5 respectively. The valve core 2 has a supplementary inlet for gas 23, the supplementary gas inlet for gas a 23 and the inlet for gas a 21 are located along the axis of the valve core 2.

The valve body 1 has a primary gasway 11 and a supplementary gasway 12 therein with a nozzle 111 installed on the outlet of primary gasway 11 and a nozzle 121 installed on the outlet of the supplementary gasway 12. The primary gasway 11 is connected with gas passage 6 directly and the supplementary gasway 12 can connect with the supplementary inlet for gas a 23; When using gas a, the inlet for gas a 21 can connect to the primary gasway 11 via gas passage 6, the supplementary gasway 12 can connect with gas passage 6 via the supplementary inlet for gas a 23 while the inlet for gas b 22 is blocked by the inside wall of valve body 1. When using gas b, inlet for gas b 22 can connect to the primary gasway 11 via gas passage 6, the inlet for gas a 21 and the supplementary inlet for gas a 23 are blocked by the inside wall of the valve body 1.

Referring to FIG. 6, the valve core 2 has an opening of a small igniter inlet 211 located beside the inlet for gas a 21, the a small igniter inlet 211 connects with the gas passage 6 and has its axis in the same cross-section of the valve core 2 with the inlet for gas a 21.

The valve core 2 has an opening of a supplementary small igniter inlet 231 located beside the supplementary inlet for gas a 23, the a supplementary small igniter inlet 231 connects with the gas passage 6 and has its axis in the same cross-section of the valve core 2 with the supplementary inlet for gas a 23.

When using gas a, turn the knob and then the knob will drive the rotary shaft and the adjusting pin the and then the valve core, therewith the gas inlet will open and the inlet for gas b will be blocked by the inside wall of the valve body. The gas flows through the gas inlet of the valve body into the inlet for gas a and to the gas passage of the core. A part of the gas in the gas passage flows out of the nozzle through the primary gasway and the other part of the gas flows through the supplementary inlet for gas a into the supplementary gasway and out of the nozzle installed on the supplementary gasway. The mixture of the gases which flow from two gasways enter into the interior of the burner. During this process, the valve body can regulate gas a to ensure the stability of combustion.

When using gas b, the knob will be pulled up from the rotary shaft and the shaft will be turned at some angle to make the inlet for gas a and the supplementary inlet for gas a blocked by the inside wall of the valve body. And then turn on the knob and then the knob will drive the rotary shaft and the adjusting pin and then the valve core, therewith the gas inlet will open and the gas flows through the gas inlet of the valve body into the inlet for gas b and to the gas passage of the core. The gas in the gas passage then flows out of the nozzle through the primary gasway. The gas enters into the interior of the burner. During this process, the valve body can regulate gas b to ensure the stability of combustion.

This operation of using gas a or gas b is independent.

This invention has the advantage in that there is no need to replace any component or part comparing to the traditional gas valve when changing the gas and it is safe and convenient for use. At the same time, waste could be reduced and the risk of incurring disastrous accident is lessened and thus benefit the mankind.

1. A shared gas valve, comprising a valve body with a valve core therein, which connects to a rotary shaft; the said valve body has a gas inlet, the said valve core has a gas passage therein with an inlet for gas a and an inlet for gas b on each side, the inlet for gas a and the inlet for gas b connect with gas passage separately; the valve core has another supplementary gas inlet for gas a; the said valve body has a primary gasway and a supplementary gasway therein and a nozzle is set at the opening of each gasway; the primary gasway is connected with gas passage directly and the supplementary gasway can connect with the a supplementary gas inlet; when using gas a, the inlet for gas a can connect with the primary gasway via gas passage, the supplementary gasway can connect with gas passage via supplementary inlet for gas a while the inlet for gas b is blocked by the inside wall of valve body; when using gas b, the inlet for gas b can connect with the primary gasway via gas passage and the inlet for gas a and the a supplementary gas inlet are blocked by the inside wall of the valve body.

2. The shared gas valve according to claim 1, wherein the said valve core has an opening of a supplementary small igniter inlet located beside the a supplementary gas inlet, the a supplementary small igniter inlet connects with the gas passage and has its axis in the same cross-section of the valve core with the a supplementary gas inlet.

3. The shared gas valve according to claim 1, wherein the inlet for gas a and inlet for gas b have their axis on the same cross-section of the said core, the supplementary gas inlet for gas a and the inlet for gas a are located along the axis of the valve core.

4. The shared gas valve according to claim 1, wherein the said valve core has an opening of a small igniter inlet located beside the inlet for gas a, the a small igniter inlet connects with the gas passage and has its axis in the same cross-section of the valve core with the inlet for gas a; the said valve core has an opening of a small igniter inlet for gas b located beside the gas inlet for gas b, the small igniter inlet for gas b connects with the gas passage and has its axis in the same cross-section of the valve core with the gas inlet for gas b.

5. The shared gas valve according to claim 4, wherein the said valve core has an opening of a supplementary small igniter inlet located beside the a supplementary gas inlet, the a supplementary small igniter inlet connects with the gas passage and has its axis in the same cross-section of the valve core with the a supplementary gas inlet.

6. The shared gas valve according to claim 4, wherein the inlet for gas a and inlet for gas b have their axis on the same cross-section of the said core, the supplementary gas inlet for gas a and the inlet for gas a are located along the axis of the valve core.
